(19) United States
(12) Patent Application Publication
(10) Pub. No.: US 2014/0006141 A1
(43) Pub. Date: Jan. 2, 2014

(54) METHODS INCORPORATING PACING CONSTRIANTS FOR BIDDING ONLINE ADVERTISEMENT DISPLAY AND APPARATUS CONDUCTING THE SAME

(71) Applicants: Sergei Vassilvitskii, New York, NY (US); Patrick R. Jordan, Mountain View, CA (US); Chris Leggetter, Belmont, CA (US); Prabhakar Krishnamurthy, Pleasanton, CA (US); David Pardoe, Sunnyvale, CA (US); Uri Nadav, Menlo Park, CA (US)

(72) Inventors: Sergei Vassilvitskii, New York, NY (US); Patrick R. Jordan, Mountain View, CA (US); Mohammad Mahdian, Santa Clara, CA (US); Chris Leggetter, Belmont, CA (US); Prabhakar Krishnamurthy, Pleasanton, CA (US); David Pardoe, Sunnyvale, CA (US); Uri Nadav, Menlo Park, CA (US)

(73) Assignee: Yahoo! Inc., Sunnyvale, CA (US)

(21) Appl. No.: 13/539,271

(22) Filed: Jun. 29, 2012

(51) Int. Cl. G06Q 30/02

(52) U.S. Cl. 705/14.45; 705/14.71

(57) ABSTRACT

The present application relates to systems and computer-implemented methods for determining a future bidding strategy regarding auctions associated with realization of an online advertisement. In some implementations, a server may be used to determine an optimized bid pacing parameter for an online advertisement based on a current bid pacing parameter associated with the online advertisement and an online advertisement supply information for a time period so that based on the optimized bid pacing, realization of the online advertisement over the time period substantially confirms to a spending strategy associated with the online advertisement during the time period. As such, the systems and computer-implemented methods may allow advertisers to control their spending strategy accurately during an advertising campaign.

### BACKGROUND

Online advertising is a form of promotion that uses the Internet and World Wide Web to deliver marketing messages to attract customers. Examples of online advertising include contextual ads on search engine results pages, banner ads, blogs, Rich Media Ads, Social network advertising, interstitial ads, online classified advertising, advertising networks, and e-mail marketing.

Ad exchanges are organization systems that associate ad buyers (e.g., advertisers and/or agents) or ad sellers (e.g., publishers) for online advertising. For example, an ad exchange may be a platform for online auctions to facilitate buying or selling of online advertisement inventory from multiple ad networks. Here “ad networks” may refer to aggregation of ad space supply from publishers, such as for provision en masse to advertisers. An example of ad exchange is Right Media Exchange (RMX) owned by Yahoo!, which is a marketplace of online advertising that enables advertisers, publishers, and ad networks to trade digital media through an application programming interface. Through a form of online auction, RMX provides publishers, i.e., media sellers, the visibility and control necessary to maximize yield while driving engagement and return on advertisement spending for media buyers. On the other hand, the expressive nature of RMX allows advertisers and/or agents to condition their bids upon various user demographic and behavioral features, and with the inclusion of real-time bidding (RTB), advertisers and/or agents may condition their bids upon information that is not available to the exchange through the use of third-party information brokers.

Thus by its nature, a modern ad exchange is a complex multi-agent system comprising multiple market participants, such as advertisers, publishers, and networks. This characteristic of modern ad exchanges provides for the ability to automate many of the strategic decisions that are made by the market participants. For example, advertising campaign optimizer agents that incorporate high-level goals elicited from advertisers may implement strategic bidding behavior on behalf of the advertisers.

One of the challenges in making strategic decisions is how an advertiser plans his/her bidding strategy in an advertising campaign. In an online advertising campaign, an advertiser normally has a pre-decided spending budget or bidding plan for online advertisement display. Under traditional methods, if the advertiser obtains advertisement display opportunities through online auctions, he/she normally keeps bidding the auctions until the entire budget is spent. Alternatively, the advertiser may divide the spending budget into a number of sub-budgets according to the time duration (e.g., days or hours) of the advertising campaign, and then keep bidding the advertisement opportunities within one period of time until the entire sub-budget is spent. Here, the advertiser may include the advertising entity who plans to conduct online advertisement display campaign and any agents who conduct the campaign on behalf of the advertising entity.

Although the second method provides the advertiser the ability to make finer adjustment to his/her spending during the campaign than the first method, both methods are not reactive enough to real-time changes in an online advertising marketplace, and the advertiser cannot precisely control his/her spending as he planned. Thus, both methods have disadvantages in that they rely heavily on the display and prices prediction for extended periods of time that occur in the future.

### BRIEF DESCRIPTION OF THE DRAWINGS

The systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates a procedure for an online auction.

FIG. 2 is a schematic illustration of an auction scheme using a second-price rule;

FIG. 3 illustrates a database of historical auctions;

FIG. 4 illustrates a section of the database of historical auctions;

FIG. 5(a) illustrates an example of a linear spending plan;

FIG. 5(b) illustrates an example of a front loading spending plan;

FIG. 5(c) illustrates an example of a back loading spending plan;

FIG. 5(d) illustrates an example of a spending plan having a continuous curve with respect to time;

FIG. 6 illustrates an example showing an out-of-phase relationship between a spending plan and traffic associated with an advertisement display opportunity over a period of time; and

FIG. 7 illustrates one implementation of a method for incorporating pacing constraints in bidding for online advertisement display opportunities.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments and/or implementations.

Example embodiments and/or implementations of the present application relate to systems and methods for online tracking of a pre-specified spending strategy during an advertising campaign. By updating a bidding strategy according to a forecast of online advertisement supply, the systems and methods may allow an advertiser to achieve a pre-specified spending strategy in the advertising campaign. Comparing to the traditional methods stated above, the systems and methods of the present application are far more reactive and depend on the bidding performance of the advertiser in a short previous time periods rather than on the display and prices prediction for extended periods of time.

For a better understanding of the present application, network environments and online advertising environments that example embodiments of the present application may be implemented in are first introduced as follow.

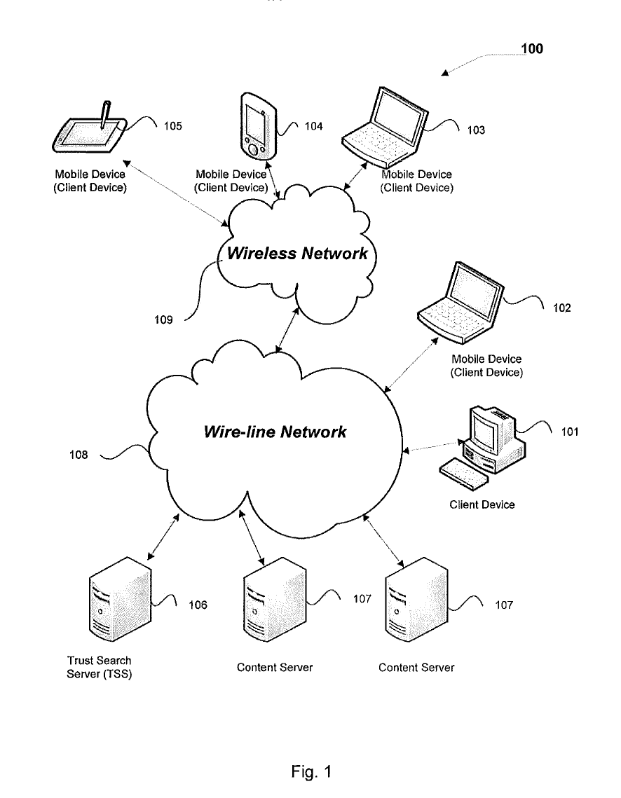

FIG. 1 is a schematic diagram illustrating one embodiment of a network environment in which system and methods for online tracking of a budget to adjust a bidding agent to follow a pre-specified spending plan may operate. Other embodiments of the network environments may vary, for example, in terms of arrangement or in terms of type of components, are also intended to be included within claimed subject matter. As shown, FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., content server 107 and search server 106) and client devices (e.g., client device 101-105 and mobile device 102-105) or other types of devices, including between wireless devices coupled via a wireless network, for example. A network 100 may also include mass storage, such as network attached storage (NAS), a storage area network (SAN), or other forms of computer or machine readable media, for example.

A network may also include any form of other implements that connect individuals via communications network or via a variety of sub-networks to transmit/share information. For example, the network may include content distribution systems, such as peer-to-peer network, or social network. A peer-to-peer network may be a network employ computing power or bandwidth of network participants for coupling nodes via an ad hoc arrangement or configuration, wherein the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link. Overall, any type of network, traditional or modern, that may facilitate information transmitting or advertising is intended to be included in the concept of network in the present application.

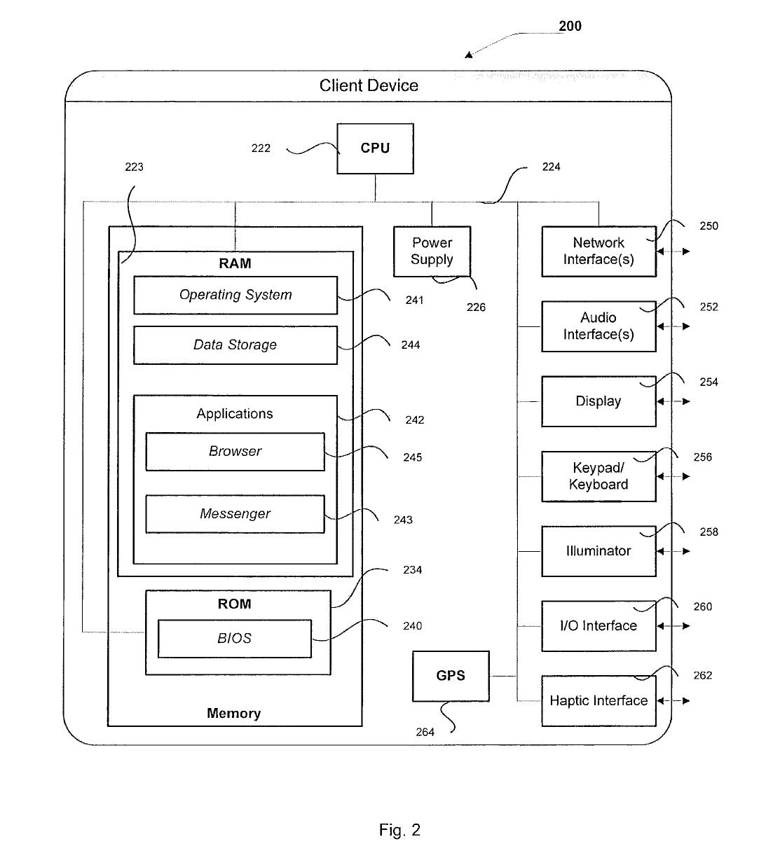

FIG. 2 is a schematic diagram illustrating an example embodiment of a client device, which may be used by an advertiser in conducting online advertising campaigns. A client device may include a computing device capable of sending or receiving signals, such as via a wired or a wireless network. A client device may, for example, include a desktop computer 101 or a portable device 102-105, such as a cellular telephone or a smart phone 104, a display pager, a radio frequency (RF) device, an infrared (IR) device, a Personal Digital Assistant (PDA), a handheld computer, a tablet computer 105, a laptop computer 102-103, a set top box, a wearable computer, an integrated device combining various features, such as features of the forgoing devices, or the like.

A client device may vary in terms of capabilities or features. Claimed subject matter is intended to cover a wide range of potential variations. For example, a client device may include a keypad/keyboard 256 or a display 254, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 264 or other location-identifying type capability, or a display with a high degree of functionality, such as a touch-sensitive color 2D or 3D display, for example.

A client device may include or may execute a variety of operating systems 241, including a personal computer operating system, such as a Windows, iOS or Linux, or a mobile operating system, such as iOS, Android, or Windows Mobile, or the like. A client device may include or may execute a variety of possible applications 242, such as a browser 245 and/or a messenger 243. A client application 242 may enable communication with other devices, such as communicating one or more messages, such as via email, short message service (SMS), or multimedia message service MMS), including via a network, such as a social network, including, for example, Facebook, LinkedIn, Twitter, Flickr, or Google, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games such as fantasy sports leagues). The foregoing is provided to illustrate that claimed subject matter is intended to include a wide range of possible features or capabilities.

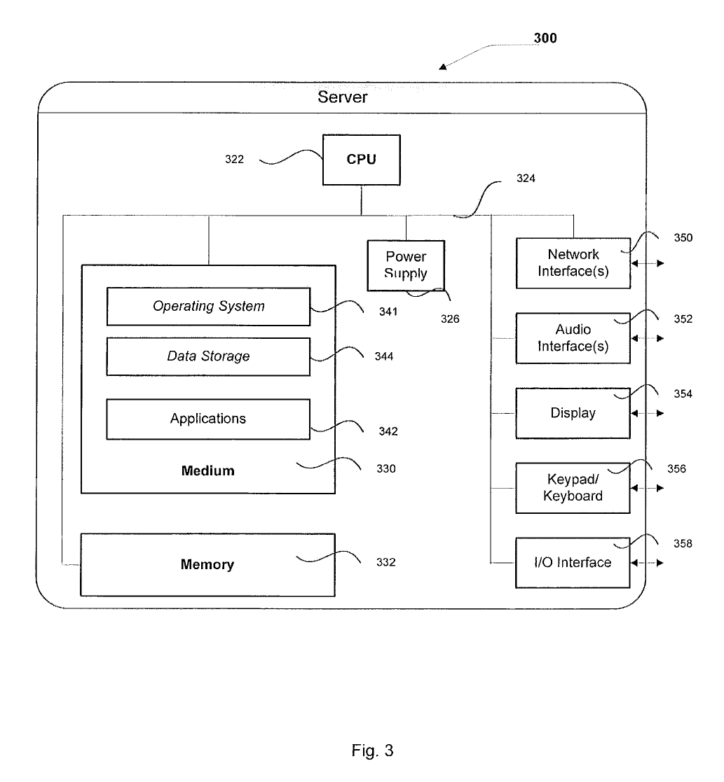

FIG. 3 is a schematic diagram illustrating an example embodiment of a server. A Server 300 may vary widely in configuration or capabilities, but it may include one or more central processing units 322 and memory 332, one or more medium 630 (such as one or more mass storage devices) storing application programs 342 or data 344, one or more power supplies 326, one or more wired or wireless network interfaces 350, one or more input/output interfaces 358, and/or one or more operating systems 341, such as Windows Server, Mac OS X, Unix, Linux, FreeBSD, or the like. Thus a server 300 may include, as examples, dedicated rack-mounted servers, desktop computers, laptop computers, set top boxes, integrated devices combining various features, such as two or more features of the foregoing devices, or the like.

The server 300 may serve as a search server 106 or a content server 107. A content server 107 may include a device that includes a configuration to provide content via a network to another device. A content server may, for example, host a site, such as a social networking site, examples of which may include, but are not limited to, Flicker, Twitter, Facebook, LinkedIn, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor type or programmable consumer electronics, etc.

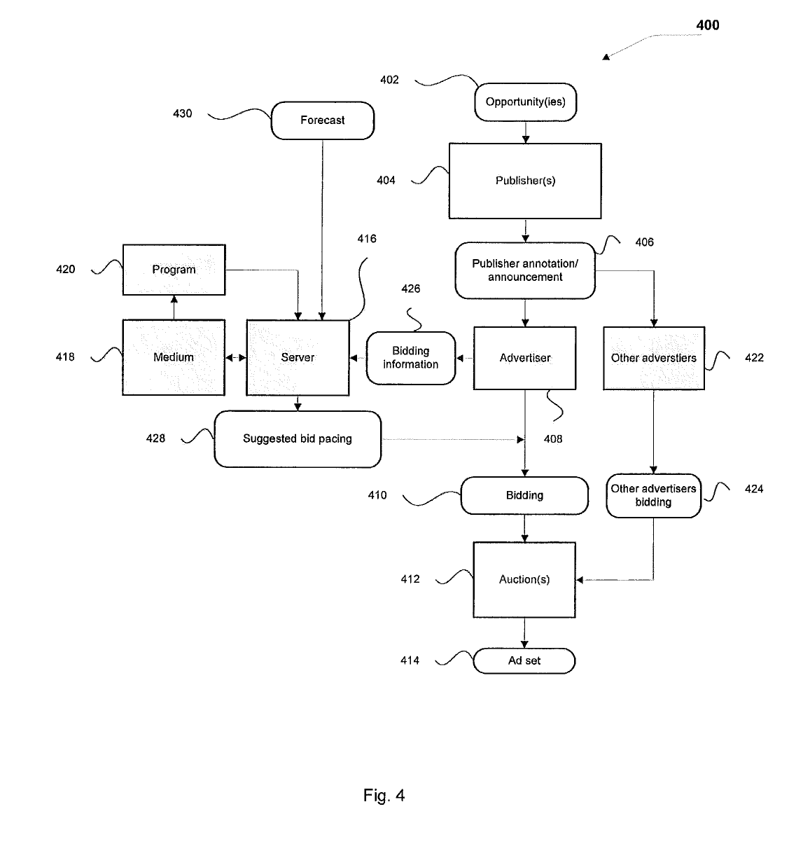

FIG. 4 is a block diagram of one example embodiment illustrating one implementation of a procedure of an online advertisement auction. However, it should be appreciated that the systems and methods described below are not limited to use with an auction for online advertisement display. In the context of ad exchange, a webpage of a publisher 404 may be viewed by various viewers and/or internet users for a number of times in a particular time period (e.g., a webpage may be visited by viewers/users a million times per day). Every time when a webpage of a publisher 404 is viewed, an online advertising opportunity 402 may be created. The publisher 404 may monetize the opportunity 402 by providing the opportunity 402 to advertisers 408, 422, who are targeting their advertisements to specific users, to realize an online advertisement on that webpage through ad network/exchanges. Here, the advertiser may be any interested parties and the realization may be of any form. For convenient purposes, the present application uses display of an advertisement impression as an example of advertisement realization, but it should be noted that the description intends to include all forms of realization associated with online advertisements. For example, realization of an online advertisement may include an impression of an online advertisement, a click-through associated with an online advertisement, an action associated with an online advertisement, an acquisition associated with an online advertisement, a conversion associated with an online advertisement, or any other type of realization associated with an online advertisement that is known in the art.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements may include employing demographic characteristics (e.g., age, income, sex, occupation, etc.) for predicting user behavior, such as by group. Advertisements may be presented to users in a targeted audience based at least in part upon predicted user behavior(s). Another approach may include profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Thus, for each online advertisement to be shown, the publisher 404 may make an annotation/announcement 406, informing advertisers 408, 422 who may be interested in the online advertisement display opportunity 402 with relevant information thereof. The relevant information may include, but may not be limited to, an advertisement key word, the website visiting information, information related to where the advertisement will be shown (such as the section of a webpage, a Uniform Resource Locater (URL) of the webpage, a location on the webpage, and/or a size of the advertisement on the webpage) and/or information about the viewers (such as their demographic information, geographic information, and/or information stored in cookies of their computer and/or internet surfing devices) of this opportunity.

Once the advertisers 408, 422 receive the annotation 406 of the online advertisement display opportunity 402 from the publisher 404, the publisher 404 may seek monetizing the online advertisement display opportunity 402 by holding an online advertisement auction 412 among the advertisers 408, 422.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as pay-per-impression, pay-per-click, pay-per-acquisition, or any other online advertisement auction methodology known in the art. Formation of the online advertisement auction 412 may adopt a first-price rule, where the winning advertiser pays its bid, or a second-price rule, where the winning advertiser pays the minimum amount required to outbid the second-highest competitor, or any other online advertisement auction methodology known in the art. Advertiser payment for online advertising may be divided between parties including one or more publishers or publisher networks, one or more marketplace facilitators or providers, or potentially among other parties. Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

Referring back to FIG. 4. In the context of ad exchanges, there may have multiple online advertisement display opportunities 402 occur, either from a same publisher or from different publishers, during a period of time. Each online advertisement display opportunity corresponds to an online advertisement auction 412 and in each online advertisement auction 412 there may be multiple advertisers 408, 422 participating in bidding. Each advertiser 408, 422 may independently and intelligently bid according to their knowledge of similar online advertisement auctions. Further, each advertiser 408, 422 may have his/her own spending strategy (e.g., spending or bidding plan) and/or budget associated with one or more strategic market variables (e.g., bidding prices) of online advertisement displays. For example, an advertiser may set up on his preference a pacing rule of bidding the auctions of advertisement display, which may specify how much to spend for a particular traffic (i.e., frequency of online advertisement display, or the volume of viewers/users of the webpage during a unit period of time) of advertisement display on Monday or between 6-9 a.m. in the morning.

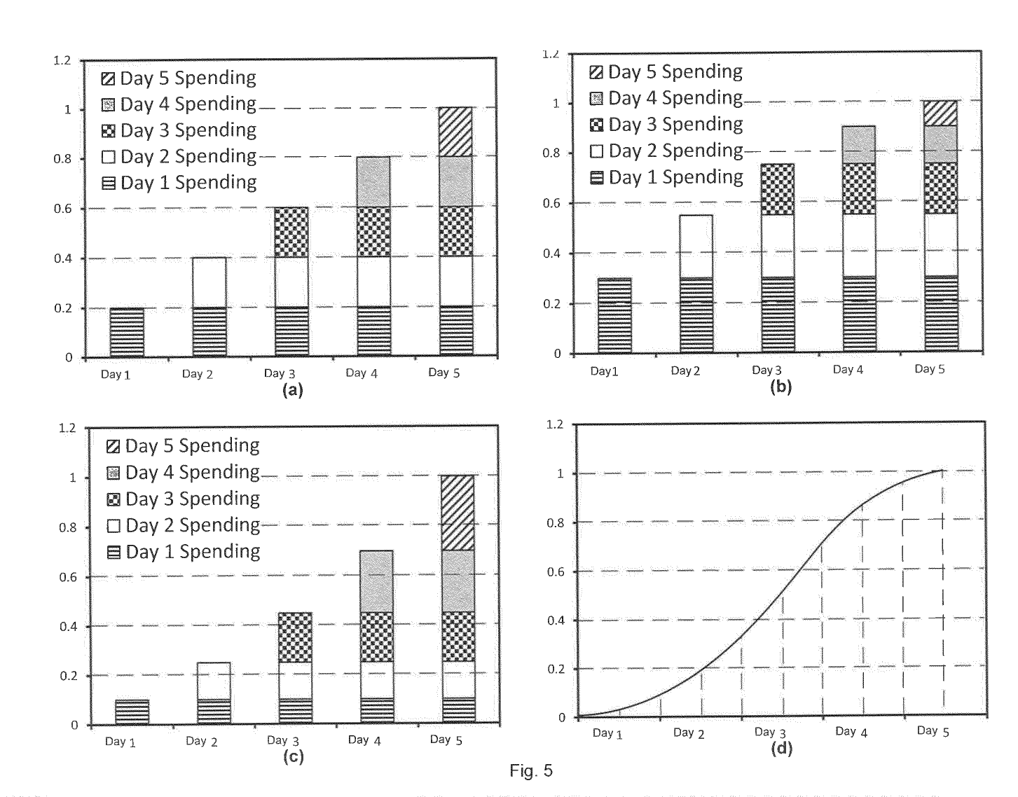

Various spending strategies may be used by the advertiser 408, 422. FIGS. 5(a)-(d) illustrate four non-exclusive examples of spending strategy in a 5-day advertising campaign that the present application may adopt. FIG. 5(a) illustrates a linear spending plan, wherein the overall budget is evenly divided to each day of the advertising campaign. For example, in FIG. 5(a) the spending plan evenly distributes the overall budget in five days, so that the advertiser 408, 422 may spend 20% of the overall budget in each of the five days in the advertising campaign. Alternatively, the advertiser may have a higher focus on a particular time period, such as the weekend, in an online advertising campaign and wish to spend more on that particular time period, but at the same time still wish to have his/her advertisements be displayed in other days of the campaign. Depending on when the focused period of time occurs, a spending plan may be categorized as a front loading spending plan or a back loading spending plan. FIG. 5(b) illustrates a front loading spending plan, wherein the advertising campaign budget dissipates faster in an early period of the advertising campaign. For example, in FIG. 5(b) the advertising campaign budget plans to spend 30% of the overall budget in each of the first three days in the advertising campaign and spend 5% of the overall budget in each of the last two days of the advertising campaign. FIG. 5(c) illustrates a back loading spending plan, wherein the advertising campaign budget dissipates faster in a later period of the advertising campaign. For example, in FIG. 5(c) the advertising campaign budget plans to spend 5% in the first day, 10% in the second day, 15% in the third day, 30% in the fourth day, and 40% in the fifth day.

It should be appreciated that the present application may implement any type of spending plan as a spending strategy. For example, the spending strategy may be any combination of linear, front loading, and back loading spending plan. Moreover, for those advertising campaigns that are time sensitive, the spending plan may even be a continuous curve with respect to the time, such as the example shown in FIG. 5(c).

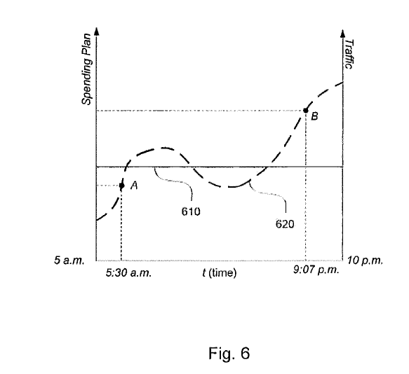

However, it should also be noted that the traffic and price associated with online advertisement display opportunities may vary during an online advertising campaign. For example, the visiting traffic of an entertainment webpage may fluctuate continuously during a week, wherein the traffic is heavier in the night than during a day and is heavier in the weekend than during the week. Such fluctuation may not necessarily be in-phase with the spending strategy of the advertiser. FIG. 6 is an example showing an out-of-phase relationship between a spending strategy and the traffic of advertisement display opportunity. In FIG. 6, although the spending plan 610 is linear, i.e., the advertiser plans to spend his/her budget at a constant rate from 5 a.m. to 10 p.m. on bidding some online advertisement display opportunities, the traffic 620 of the online advertisement display opportunities (i.e., frequency that the online advertisement display opportunities occur or volume of viewers/users of the webpage during a unit period of time), is not constant. As shown in FIG. 6, the traffic 620 may be lighter at 5 a.m. and heavier at 10 p.m. with certain fluctuation therebetween. The traffic at 5:30 a.m. (i.e., point A) is approximately half of the traffic at 9:07 p.m. (i.e., point B). Therefore, the advertiser may control/adjust his/her actual bid pacing according to the traffic fluctuation in order to keep the spending rate constant over time as scheduled when the traffic of online advertisement opportunity is not in-phase, wherein the bid pacing for an online advertisement may be a measure of a number of auctions for online advertisement display opportunities that an advertiser would like to participate in per unit of time or per unit of online advertisement display opportunities. For example, a bid pacing parameter may be five bidding per minute, five biddings per fifty auctions. For example, when the traffic of online advertisement opportunities at 9:07 p.m. doubles the traffic of online advertisement opportunities at 5:30 a.m., the advertiser may reduce his/her bid pacing at 9:07 p.m. to half of the bid pacing at 5:30 a.m. In fact, for those advertising campaigns that are time sensitive, the bid pacing of online advertisement display auctions may need real-time monitoring and/or adjustment in order to match the pre-specified spending strategy.

Referring back to FIG. 4. To ensure that the pre-specified spending strategy may be successfully executed, an advertiser 408 may send to the server 416 his/her bidding information 426. The server 416 may then access a computer-readable storage medium 418 and execute a set of instructions/programs 420 stored therein for incorporating constraints in bidding for online advertisement display opportunities. As a result, the server 416 may calculate a suggested bidding strategy for the advertiser 408, so that if the advertiser 408 bid the online advertisement opportunities with the suggested bidding strategy in a next pre-defined time period, the actual spending on purchasing the online advertisement display opportunities may conform to the pre-specified spending strategy.

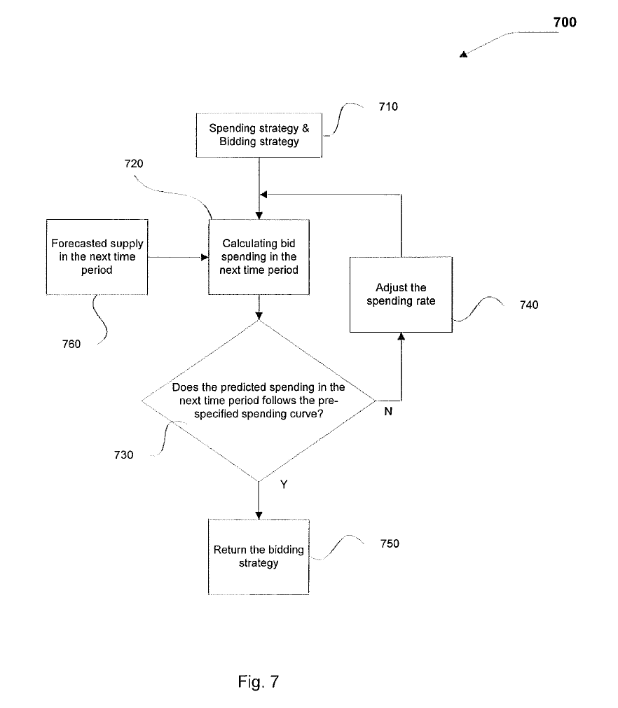

FIG. 7 illustrates one implementation of a method for incorporating constraints in the bidding strategy for online advertisement display opportunities that the instructions/programs 420 may utilize and/or the server 416 may execute. In the implementation, the bidding strategy is bid pacing, and the server 416 calculates a bid pacing parameter, which may be the number of auctions for online advertisement display opportunities that an advertiser would like to participate in per unit of time or per unit of online advertisement display opportunities. However, it should be note that any other bidding strategies may also be applicable to the method.

According to FIG. 7, the server 416 may first receive bidding information 426. The bidding information 426 may include, but is not limited to, a pre-specified spending strategy (e.g., spending plan and/or spending rate) of the advertiser 408, the present bid pacing parameter of the advertiser 408, and/or information of the online advertisement display opportunity 402 that the advertiser 408 is interested in. The server 416 may also receive either from the advertiser 416 or from an external source a forecast 430 of online advertisement display supply (i.e., the number of online advertisement display opportunities that will occur in a next pre-defined time period) and/or price thereof of the next pre-defined time period. If the length of the next pre-defined time period is short, the forecast may be a real-time forecast. Further, the server 416 may further receive any other relevant information useful for formulating the bid pacing constraints, such as the amount of the budget for the online advertising campaign and the amount of money left in the budget.

After receiving the above information, the server 416 may utilize any pertinent methods to calculate the bid pacing parameter for the next pre-defined time period. For example, the server 416 may directly calculate an optimized bid pacing parameter for the next pre-defined time period based on information such as the spending rate and the forecasted bidding price and/or the online advertisement display supply 430 of the next pre-defined time period, so that the spending of online advertisement auction for the next pre-defined time period may conform to the spending rate of the budget for the online advertising campaign. For example, if in the next time period the supply is forecasted to be the same price but twice as much as the immediate previous time period, but according to the pre-specified spending strategy the total amount of spending in both time periods is the same, the rate of spending in the next time period may be cut down to half the bid pacing in the immediate previous time period.

Alternatively, the server 416 may utilize a recursive algorithm to adjust the bid pacing parameter for the next pre-defined period of time based on the current bid pacing parameter. For example, at step 720, the server 416 may first calculate the spending and/or spending rate for the next pre-defined period of time based on the current bid pacing parameter. Then at step 730, the server 416 may determine whether the calculated spending and/or spending rate in the next pre-specified period of time conform to the pre-specified spending strategy, e.g., whether the advertiser 408 will spend exactly the amount as planned if he/she keeps using the current bid pacing. If the calculated spending and/or spending rate in the next pre-specified period of time conforms to the pre-specified spending strategy, the server 416 may return to the advertiser 416 the current bid pacing parameter at step 750 as the optimized bid pacing parameter. However, if the calculated spending and/or spending rate in the next pre-specified period of time do not conform to the pre-specified spending strategy, the server 416 may perform step 740 to adjust the bid pacing parameter and return to step 720. For example, if the calculated spending rate in the next pre-specified period of time is lower than the pre-specified spending strategy, the server 416 may increase the bid pacing parameter so that the advertiser may bid more frequently in the next pre-specified period of time. Conversely, if the calculated spending rate in the next pre-specified period of time is faster than the pre-specified spending strategy, the server 416 may decrease the bid pacing parameter so that the advertiser may bid less frequently in the next pre-specified period of time. The server 416 may perform steps 720-740 repeatedly until the calculated spending in the next pre-specified period of time conforms to the pre-specified spending strategy, and then return to the advertiser 416 the current bid pacing parameter at step 750 as the optimized bid pacing parameter.

As described above, systems and computer-implemented methods may provide for online tracking of a budget to adjust a bidding agent to follow a pre-specified spend plan. By monitoring the rate at which the bidding agent is spending the money and, together with a forecast of online advertisement display supply, systems and computer-implemented methods may adjust the rate higher or lower to follow the pre-specified spending strategy. In addition, the present application also provides programs adopting the described methods, wherein the programs comprise instructions stored on a computer-readable storage medium that may be executed by a processor of a device such as servers.

The systems and computer-implemented methods may expose the pacing controls explicitly to advertisers, allowing for a greater diversity of different pacing metrics. The systems and methods may also actively monitors the rate of spending, obviating the traditional need for a heavy duty offline optimization.

However, it is intended that the foregoing detailed description be regarded as illustrative rather than limiting, and that it be understood that it is the following claims, including all equivalents, that are intended to define the spirit and scope of this invention.

For example, while the above-described systems and methods have been described with respect to online tracking of a budget for advertisement display auctions, it will be appreciated that the same systems and methods may be implemented to track other market variables of auctions, and the auctions may or may not be related to advertisement display.

Further, while the above-described systems and methods have been described with respect to track market variables of online auctions, it will be appreciated that the same systems and methods may be implemented to track the market variables of auctions that are not held online and/or not related to online activities.

Also, while the above-described systems and methods have been described with respect to track market variables of auctions held by publishers and bided by advertisers, it will be appreciated that the same systems and methods may be implemented to track market variables of auctions held by any auction holder and bided by any auction attendances.

In addition, while example embodiments have been particularly shown and described with reference to FIGS. 1-7, it will be understood by one of ordinary skill in the art that various changes in form and details may be made therein without departing from the spirit and scope of example embodiments, as defined by the following claims. The example embodiments, therefore, are provided merely to be illustrative and subject matter that is covered or claimed is intended to be construed as not being limited to any example embodiments set forth herein. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in one example embodiment” as used herein does not necessarily refer to the same embodiment and the phrase “in another embodiment” or “in another example embodiment” as used herein does not necessarily refer to a different embodiment. It is intended, for example, that claimed subject matter include combinations of example embodiments in whole or in part.

The terminology used in the specification is for the purpose of describing particular embodiments only and is not intended to be limiting of example embodiments of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

We claim:

1. A computer-implemented method for determining an optimized bid pacing parameter associated with an online advertisement, the method comprising:
receiving online advertisement supply information for a time period, the online advertisement supply information providing an estimate of a number of online advertisement realization opportunities during the time period;
determining an optimized bid pacing parameter for an online advertisement based on a current bid pacing parameter associated with the online advertisement and the online advertisement supply information for the time period so that based on the optimized bid pacing, realization of the online advertisement over the time period substantially confirms to a spending strategy associated with the online advertisement during the time period; and
returning the optimized bid pacing parameter associated with the online advertisement.

2. The computer-implemented method according to claim 1, wherein the spending strategy for the next period of time is one of a continuous spending curve having a value varying with respect to time and a spending budget having discretized varying values each associated with a period of time.

3. The computer-implemented method according to claim 1, wherein the online advertisement supply information of a next time period regarding realizing the online advertisement is a real-time forecast and the supply varies with respect to time.

4. The computer-implemented method according to claim 1, further comprising:
receiving a bidding price forecast regarding auctions associated with realizing the online advertisement, wherein the bidding prices are predicted using computer simulations.

5. The computer-implemented method according to claim 1, wherein the bid pacing comprises a rate of bidding at which a bidding agent is spending money.

6. The computer-implemented method according to claim 1, wherein the determining the optimized bid pacing parameter comprises increasing the current bid pacing parameter in the next time period when the supply regarding realization of the online advertisement decreases and decreasing the current bid pacing parameter in the next time period when the supply of the next time period regarding realization of the online advertisement increases.

7. The computer-implemented method according to claim 1, wherein realization of the online advertisement comprises at least one of an impression of the online advertisement, a click through associated with the online advertisement, an action associated with the online advertisement, an acquisition associated with the online advertisement, and a conversion associated with the online advertisement.

8. A computer-readable storage medium comprising a set of instructions for determining an optimized bid pacing parameter associated with an online advertisement, the set of instructions to direct a processor to perform acts of:
receiving online advertisement supply information for a time period, the online advertisement supply information providing an estimate of a number of online advertisement realization opportunities during the time period;
determining an optimized bid pacing parameter for an online advertisement based on a current bid pacing parameter associated with the online advertisement and the online advertisement supply information for the time period so that based on the optimized bid pacing, realization of the online advertisement over the time period substantially confirms to a spending strategy associated with the online advertisement during the time period; and
returning the optimized bid pacing parameter associated with the online advertisement.

9. The computer-readable storage medium according to claim 8, wherein the spending strategy for the next period of time is one of a continuous spending curve having a value varying with respect to time and a spending budget having discretized varying values each associated with a period of time.

10. The computer-readable storage medium according to claim 8, wherein the online advertisement supply information of a next time period regarding realizing the online advertisement is a real-time forecast and the supply varies with respect to time.

11. The computer-readable storage medium according to claim 8, wherein performing the acts further comprises:
receiving a bidding price forecast regarding auctions associated with realizing the online advertisement, wherein the bidding prices are predicted using computer simulations.

12. The computer-readable storage medium according to claim 8, wherein the bid pacing comprises a rate of bidding at which a bidding agent is spending money.

13. The computer-readable storage medium according to claim 8, wherein the determining the optimized bid pacing parameter comprises increasing the current bid pacing parameter in the next time period when the supply regarding realization of the online advertisement decreases and decreasing the current bid pacing parameter in the next time period when the supply of the next time period regarding realization of the online advertisement increases.

14. The computer-readable storage medium according to claim 8, wherein realization of the online advertisement comprises at least one of an impression of the online advertisement, a click through associated with the online advertisement, an action associated with the online advertisement, an acquisition associated with the online advertisement, and a conversion associated with the online advertisement.

15. A server comprising:
a computer-readable storage medium comprising a set of instructions for determining an optimized bid pacing parameter associated with an online advertisement;
a processor in communication with the computer-readable storage medium that is configured to execute the set of instructions stored in the computer-readable storage medium and is configured to:
receive online advertisement supply information for a time period, the online advertisement supply information providing an estimate of a number of online advertisement realization opportunities during the time period;
determine an optimized bid pacing parameter for an online advertisement based on a current bid pacing parameter associated with the online advertisement and the online advertisement supply information for the time period so that based on the optimized bid pacing, realization of the online advertisement over the time period substantially confirms to a spending strategy associated with the online advertisement during the time period; and
return the optimized bid pacing parameter associated with the online advertisement.

16. The server according to claim 15, wherein the spending strategy for the next period of time is one of a continuous spending curve having a value varying with respect to time and a spending budget having discretized varying values each associated with a period of time.

17. The server according to claim 15, wherein the online advertisement supply information of a next time period regarding realizing the online advertisement is a real-time forecast and the supply varies with respect to time.

18. The server according to claim 15, wherein the processor if further configured to:
receive a bidding price forecast regarding auctions associated with realizing the online advertisement, wherein the bidding prices are predicted using computer simulations.

19. The server according to claim 15, wherein the bid pacing comprises a rate of bidding at which a bidding agent is spending money; and
wherein the determining the optimized bid pacing parameter comprises increasing the current bid pacing parameter in the next time period when the supply regarding realization of the online advertisement decreases and decreasing the current bid pacing parameter in the next time period when the supply of the next time period regarding realization of the online advertisement increases.

20. The server according to claim 15, wherein realization of the online advertisement comprises at least one of an impression of the online advertisement, a click through associated with the online advertisement, an action associated with the online advertisement, an acquisition associated with the online advertisement, and a conversion associated with the online advertisement.
